(19) United States
(12) Patent Application Publication
(10) Pub. No.: US 2012/0266471 A1
(43) Pub. Date: Oct. 25, 2012

(54) Square and Ruler

(76) Inventor: Albert Chao, Saddle River, NJ (US)

(21) Appl. No.: 13/092,507

(22) Filed: Apr. 22, 2011

(51) Int. Cl. B43L 7/00

(52) U.S. Cl. 33/478

(57) ABSTRACT

A combination ruler and square has first and second elongated straight ruler members with first and second recesses in the upper surface near opposite ends of the first ruler member that receive a tongue extending from an end of the second ruler member to form first and second configurations of the combination that respectively create a square and an elongated ruler. Magnets and detents in the tongue and recesses retain the tongue in a respective recess in the first and second configurations and an extra pair of alignable magnets in the first and second ruler members cause the rule members to be attracted to each other in an aligned storage configuration of the combination where the second ruler member overlays the first ruler member.

### FIELD AND BACKGROUND OF THE INVENTION

The present invention relates generally to the field of rulers and squares used for measuring, drawing, construction and the like, and in particular, to a new and useful combination ruler and square that can be configured as a 90 degree square or as a longer ruler for use, or into a shorter compact configuration for transportation and storage.

A large number of patents have sought to solve the problem of finding a way to make the large area occupied by a 90 square, smaller for storage and transport of this very useful but awkward to store and carry implement.

The usual solution suggested was been to place a hinge at the intersection of the two ruler members making up the square so that it can be folded into a more compact configuration. See for example U.S. Pat. Nos. 510,529 (1893); 551,839 (1895); 810,188 (1906); 844,420 (1907); 867,420 (1907); 1,021,850 (1912); 1,101,625 (1914); 1,209,855 (1915); 1,908,518 (1933); and 5,669,149 (1997).

U.S. Pat. No. 5,433,011 is also interesting for its showing of a multi-part level rather than a square, that can be elongated using mortis and tenon like joints.

Despite this long history of innovation in this rather simple art, a need still remains for an improved square that is easily and securely converted from its square, space using configuration, to a more convenient and practical configuration for storage and transport.

### SUMMARY OF THE INVENTION

It is an object of the present invention to provide a combination ruler and square that has simple first and second elongated straight ruler members with first and second recesses in the upper surface near opposite ends of the first ruler member that receive a tongue extending from an end of the second ruler member to form first and second configurations of the combination that respectively create a square and an elongated ruler. Magnets and detents in the tongue and recesses retain the tongue in a respective recess in the first and second configurations and an extra pair of alignable magnets in the first and second ruler members cause the rule members to be attracted to each other in an aligned storage configuration of the combination where the second ruler member overlays the first ruler member.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a top perspective view of a combination ruler and square that has first and second elongated straight ruler members according to the invention;

FIG. 2 is a bottom perspective view of the combination of FIG. 1;

FIG. 3 is a top perspective view of the combination in a first configuration forming a square;

FIG. 4 is a top perspective view of the combination in a second configuration forming an elongated ruler;

FIG. 5 is a bottom perspective view of the combination in a storage configuration;

FIG. 6 is a view similar to FIG. 1 of parts of another embodiment of the invention;

FIG. 7 is a top plan view of the other embodiment; and

FIG. 8 is a view similar to FIG. 1 of a still further embodiment of the invention.

### DESCRIPTION OF THE PREFERRED EMBODIMENTS

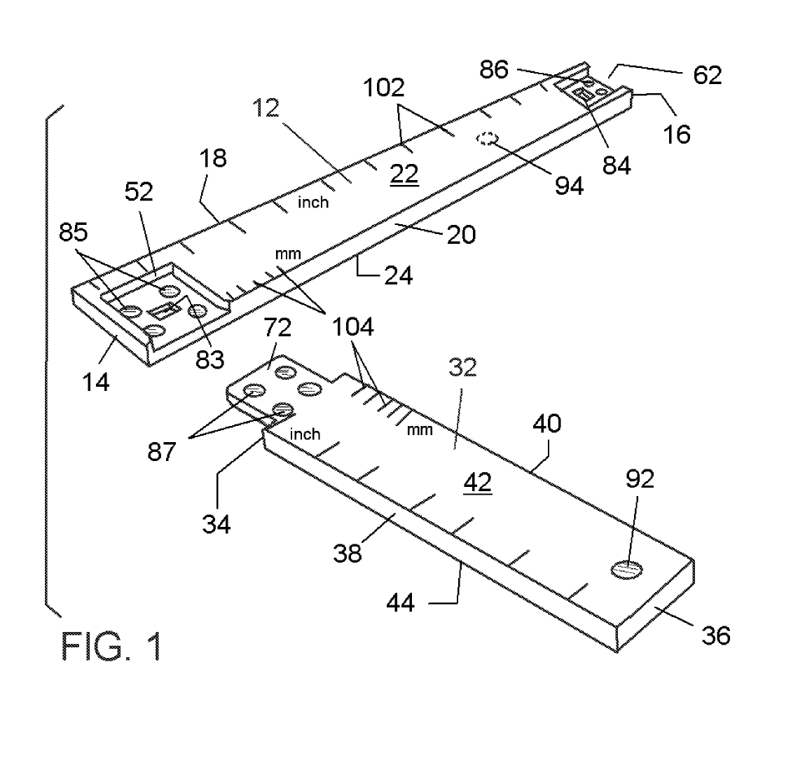

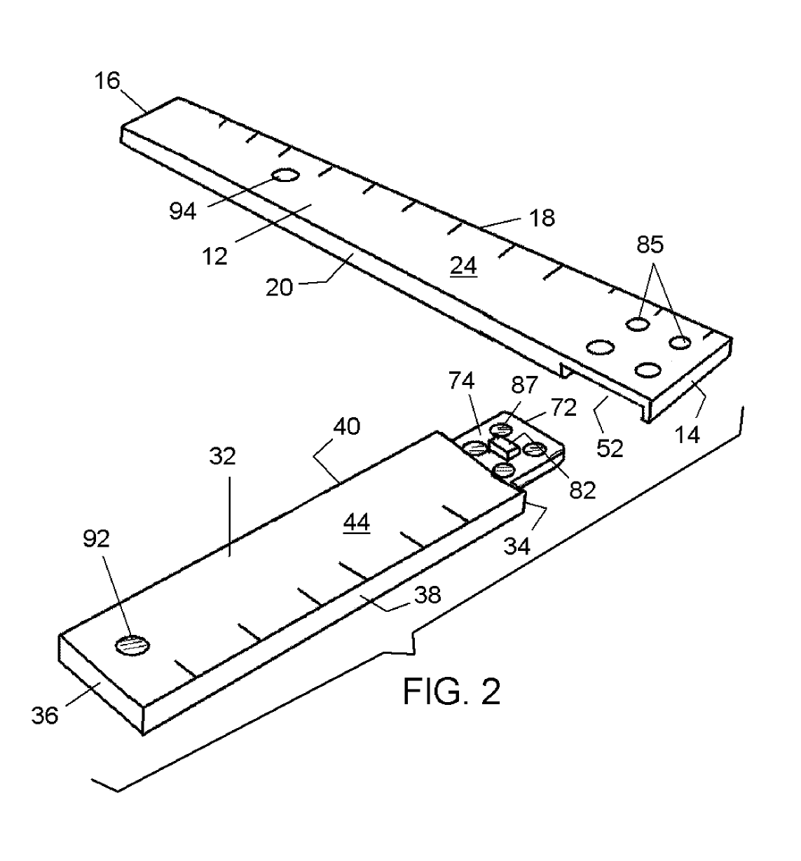

Referring now to the drawings, in which like reference numerals are used to refer to the same or similar elements, FIGS. 1 and 2 show the top and bottom of a combination ruler and square comprising a first elongated straight ruler member 12 having first and second opposite straight ends 14 and 16, opposite straight edges 18 and 20 extending between the opposite ends and upper and lower flat surfaces 22 and 24 between the ends and the edges of the first ruler member 12.

The combination includes a second elongated straight ruler member 32 having first and second opposite straight ends 34 and 36, opposite straight edges 38 and 40 extending between the opposite ends and upper and lower flat surfaces 42 and 44 between the ends and edges of the second ruler member. The first and second ruler members 12 and 32 have equal thicknesses between the upper and lower surfaces thereof and the first ruler member 12 has a first recess 52 in its upper surface 22 near its first end 14. The first recess 52 has a first flat bottom and a selected shape that is preferably but not necessarily a polygon, in particular a rectangle or square. Recess 52 has a depth from the upper surface 22 to its first flat bottom that is part, for example about ¼ to ⅔ of the total thickness of the first rule member 12, and preferably about ½ the total thickness so the overall strength of the first ruler member 12 is not overly compromised in this area of the first recess 52.

As best shown in FIGS. 1 and 2 the first recess 52 is open into one of the straight edges 20 of the first ruler member 12. The first ruler member 12 also has a second recess 62 in its upper surface 22 near its opposite second end 16, the second recess 62 having a second flat bottom and having the same selected shape and the same depth from the upper surface of the first ruler member to the second flat bottom, so that the recesses 52 and 62 are equal in shape and depth. The second recess 62, however, is open into the second end 16 of the first ruler member 12.

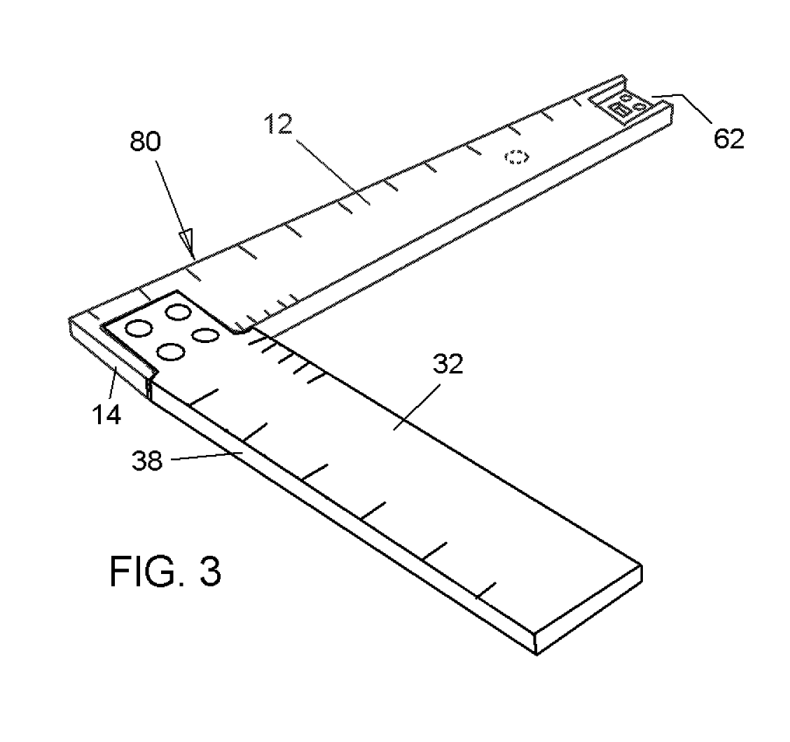

The second ruler member 32 has a tongue 72 extending from the first end 34 thereof, the tongue having substantially the same selected shape as the recess 52. Substantially the same selected shape means to convey that the tongue 72 and recess 52 are closely matched in perimeter shape and thickness with the tongue 72 being only slightly smaller in size so that the tongue 72 can be easily but closely fitted inside the recess 52 as shown in FIG. 3, and that in this engaged configuration, the upper and lower surfaces of the first and second rulers 12 and 32 are smoothly coplanar to form the square 80 of FIG. 3. The selected shape of the tongue and recesses is preferably rectangular or square but any matched shape is possible.

To this end the tongue 72 has a thickness substantially equal to the depth of each of the recesses 52 and 62 so that the tongue closely fits into both of the first and second recesses in respective first and second configurations of the combination, the tongue having an upper surface that is coplanar with the upper surface 42 of the second ruler member 32 and the upper surface of the second ruler member 32 being coplanar with the upper surface of the first ruler member 12 in the first and second configurations of the combination. The tongue 72 has a width that is offset inwardly of both of the opposite straight edges 38 and 40 of the second ruler member 32, the tongue 72 having a lower surface 74 as seen in FIG. 2, that is offset from a plane on the lower surface 44 of the second ruler member 32 by a selected amount so that in the first and second configurations of the combination, the lower surfaces of the first and second ruler members are also coplanar.

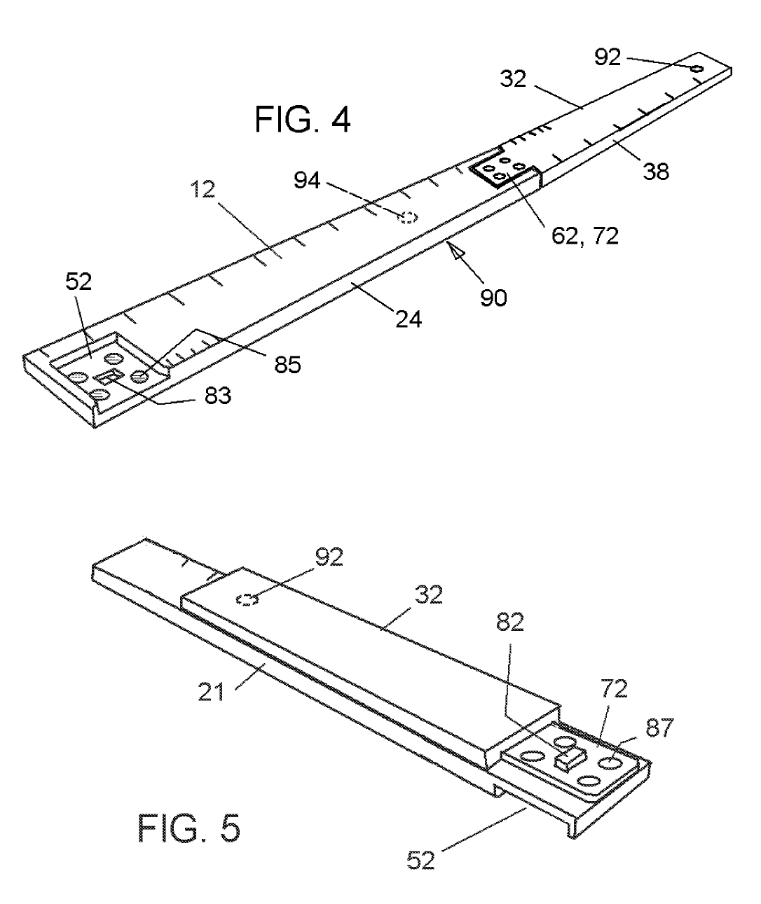

In the first configuration of the combination as shown in FIG. 3 to form a square 80, one of the opposite straight edges 38 of the second ruler member 32 is coplanar with the first straight end 14 of the first ruler member 12. FIG. 4 illustrates the second configuration 90 of the combination that forms an elongated straight ruler and wherein both of the opposite straight edges 38 and 40 of the second ruler member 32 are coplanar with the respective opposite straight edges 18 and 24 of the first ruler member 12 in the second configuration 90 of the combination to form the elongated straight ruler.

Tongue and groove sliding engagements between the side walls of the tongue 72 and the recesses 52 and 62 have been avoided since this would require a more accurate and time-consuming alignment of the tongue 72 with the recesses 52 or 62 then a sliding motion to engage them together. Instead, smooth vertical walls are used for the tongue 72 and for the recesses 52 and 62 as shown in the drawings to allow the tongue to be simply and approximately brought over the recess 52 or 62 and then moved slightly laterally until the tongue falls into the recess. This makes it easier to engage the tongue in either recess but does not sufficiently secure the two configurations against falling apart. To address this, the invention includes at least one magnet 87 in the tongue and at least one magnet 85, 86 in the first ruler member 12 in each of the first and second recesses 52, 62, that respectively align with and attract the magnet 87 in the tongue 72 in the respective first and second configurations 80 and 90 of the combination.

To mechanically keep the first and second rules together in each configuration, and therefore prevent them from sliding apart as the square or elongated ruler are being used, the invention also includes a first detent 83, 84 in the flat bottom of each of the recesses 52, 62, and a second detent 82 in the flat bottom of the tongue 72, that is shaped to engage with the first detect in the respective recesses in the first and second configurations of the combination for keeping the tongue from sliding out of the respective recess 52, 62.

In the embodiment shown the first detents 83 and 84 are female detents it the form of polygonal apertures in the flat bottom of each recess 52 and 62, that can receive the male polygonal projection 82 from the flat bottom 74 of the tongue 72 as shown in FIG. 2. Instead of polygonal detents, mating round holes or concave dimples for receiving cylindrical pegs or convex projections can be used as the first and second detents, or straight of curved slots and mating ridges or any other mating shapes for the detents can be used. Also the male and female detents may be reveres so that the female detente is in the tongue's bottom and the male detent projects from the recess bottoms.

The combination may also include an extra pair of alignable magnets 92 in ruler member 32 and 94 in ruler member 12 for causing the rule members to be attracted to each other in an aligned storage configuration shown in FIG. 5, when the second ruler member 32 overlays the first ruler member 12, with their respective upper surfaces facing each other, and the magnet 87 in the tongue being aligned with the magnet 85 in the first recess 52. This attraction keeps the ruler members together so that they can be easily stored and transported.

To better engage the tongue to either recess and to better secured the storage configuration, rather than using only one magnet in each, a plurality of magnets in each of the tongue and recesses are provided, the plurality of magnets in the tongue aligning with and having complimenting polarities to (i.e. North facing South poles), the plurality of magnets in the recesses in the respective first, second and storage configurations of the combination. In the preferred embodiment, four magnets 85, 86 and 87 are at the corners of a square in recesses 52 and 62 and in the tongue 72. With all magnets 85, 86 and 87 having their North poles up, when in the first square-forming configuration 80 of FIG. 3, the downwardly facing South poles of tongue magnets 87 face the upwardly facing North poles of magnets 85 and therefore strongly attract the tongue 72 to the recess 52. The same occurs when tongue 72 is in recess 62. In the FIG. 5, storage configuration, all the magnets are up-side-down so again there is an opposite pole attraction.

The ruler members 12 and 32 advantageously included graduated distant markings 102 and 104 on at least one of their upper and lower surfaces, along each of the opposite edges of each ruler member, the distance marking along one edge of each ruler member being English distance marking in inches and fractions therefore, and the distance marking along the opposite edge of each ruler member being metric distance marking in millimeters and centimeters for example.

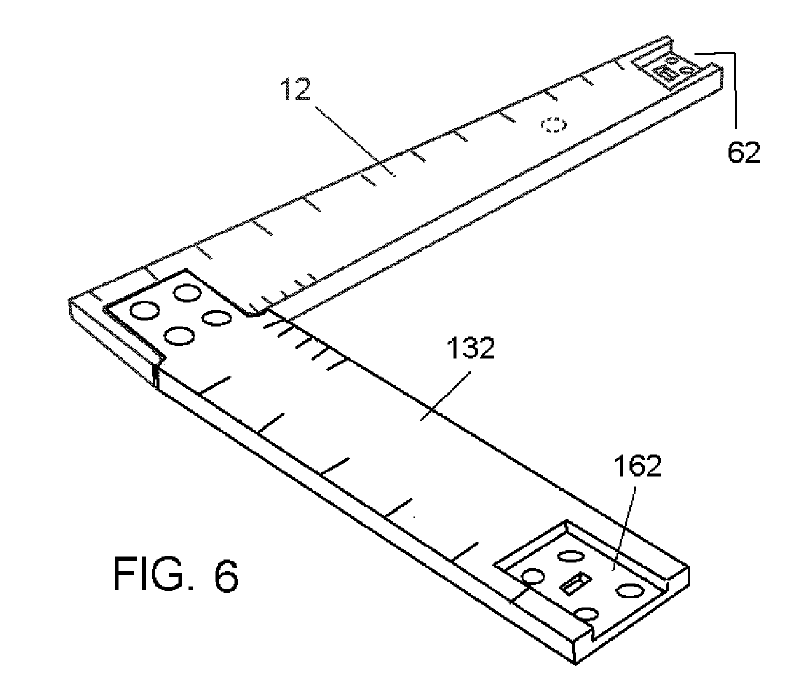

In the embodiment of FIG. 6, a third ruler member 132 is shown engaged to the first ruler member 12 in a further configuration. The second and third ruler member 32 and 132 are identical except that the third second ruler member 132 includes a third recess 162 in its upper surface near its second end, the third recess 162 having a third flat bottom and having the same selected shape as the tongue 72 and other recesses 52 and 62. The depth from the upper surface of the third ruler member 132 to the third flat bottom is equal to the depth of the first recess 52, and the third recess 162 is open into the second end of the second ruler member 132. In this way a further ruler member, like ruler member 32 of FIG. 1, can be provided in a set of three ruler members 12, 32 and 132, that can be used to increase the length of either leg of the square in configuration 80 or to greatly increase the length of one very long straight ruler in a configuration like configuration 90. The modified “second” ruler member 132 with extra recess 162, can therefore also be thought of as a third ruler member in the set of ruler member 12, 32 and 132.

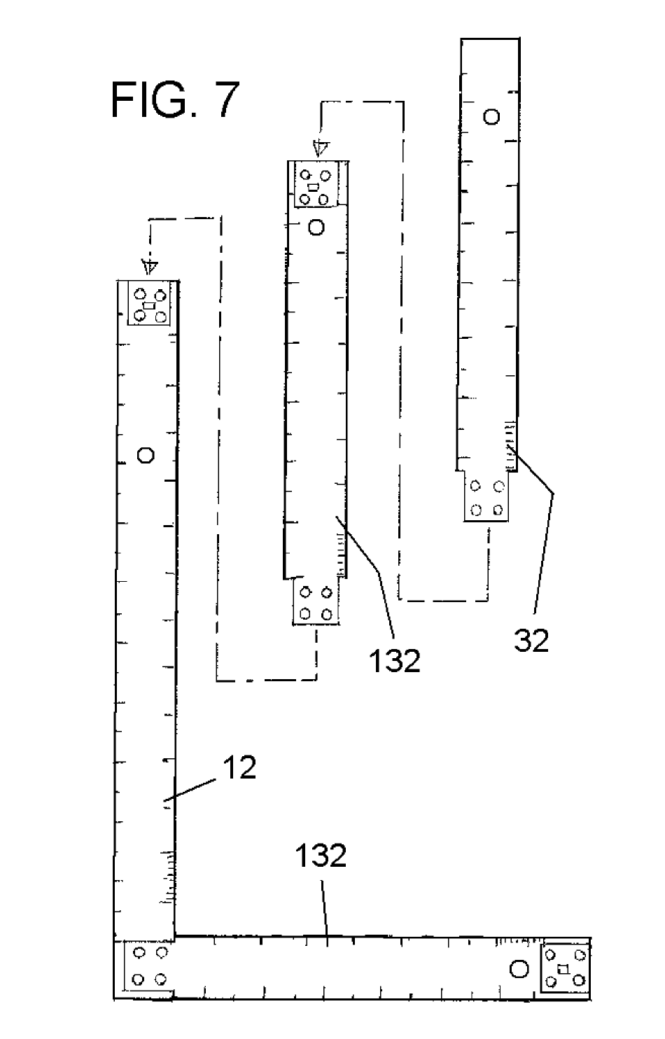

FIG. 7 illustrates a four rule member set having two such third ruler members 132, one first ruler member 12 and one second ruler member 32 of the type in FIG. 1. This four part set can be combined to make a variety of further configurations and more ruler members can be added to make even further configurations. With strategically placed extras magnets like magnet 92 in ruler member 32, near the opposite ends of each third ruler members 132, the rules can all be stacked as on FIG. 5 in a multi-layer storage configuration.

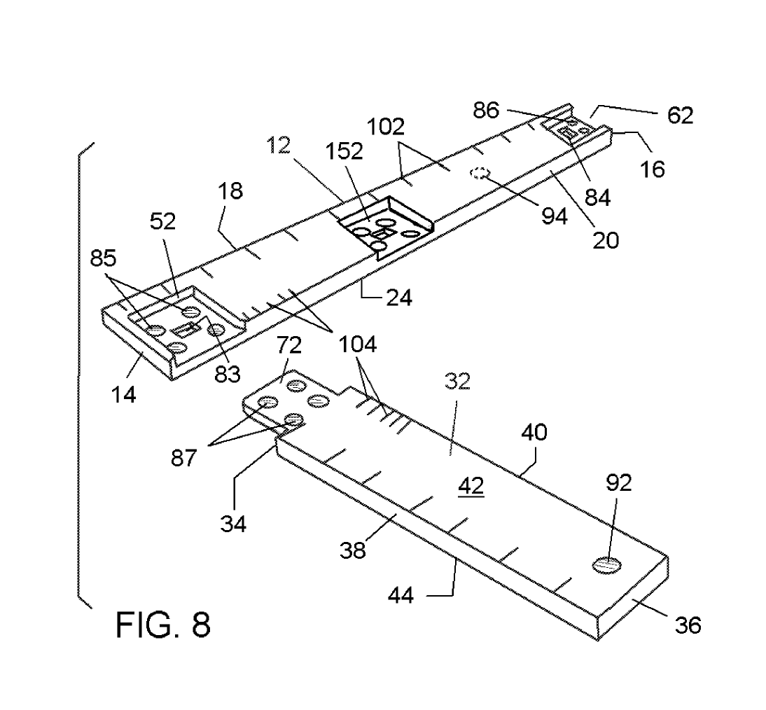

In FIG. 8 a further variation of the invention is illustrated with a recess 152 that may be spaced from the first end 14 and even centered on the first ruler member 12 to create, with the engaged second or third ruler member 32 or 132, a T-square or offset square. The other end recess 52 may be retained so that both types of squares can be made or only the end recess 62 and middle (or near middle) recess 152 used.

While specific embodiments of the invention have been shown and described in detail to illustrate the application of the principles of the invention, it will be understood that the invention may be embodied otherwise without departing from such principles.

What is claimed is:

1. A combination ruler and square comprising:
a first elongated straight ruler member (12) having first and second opposite straight ends (14, 16), opposite straight edges (18, 20) extending between the opposite ends and upper and lower flat surfaces (22, 24) between the ends and edges of the first ruler member (12);
a second elongated straight ruler member (32) having first and second opposite straight ends (34, 36), opposite straight edges (38, 40) extending between the opposite ends and upper and lower flat surfaces (42, 44) between the ends and edges of the second ruler member;
the first and second ruler members (12, 32) having equal thicknesses between the upper and lower surfaces thereof;
the first ruler member having a first recess (52) in its upper surface (22), the first recess (52) having a first flat bottom and a selected shape, a depth from the upper surface of the first ruler member to the first flat bottom being part of the thickness of the first rule member (12), and the first recess (52) being open into one of the straight edges of the first ruler member;
the first ruler member (12) also having a second recess (62) in its upper surface (22) near its second end (16), the second recess (62) having a second flat bottom and having said selected shape, a depth from the upper surface of the first ruler member to the second flat bottom being equal to said depth of the first recess (52), and the second recess (62) being open into the second end (16) of the first ruler member (12);
the second ruler member (32) having a tongue (72) extending from the first end (34) of the second ruler member, the tongue having substantially said selected shape and having a thickness substantially equal to said depth so that the tongue closely fits into both of said first and second recesses in respective first and second configurations of the combination, the tongue having an upper surface that is coplanar with the upper surface (42) of the second ruler member (32) and the upper surface of the second ruler member (32) being coplanar with the upper surface of the first ruler member (12) in the first and second configurations of the combination, the tongue (72) having a width that is offset inwardly of both of the opposite straight edges (38, 40) of the second ruler member, the tongue (72) having a lower surface (74) that is offset from a plane on the lower surface (44) of the second ruler member (32) by a selected amount so that in the first and second configurations of the combination, the lower surfaces of the first and second ruler members are also coplanar, both of the opposite straight edges (38, 40) of the second ruler member (32) being coplanar the respective opposite straight edges (18, 24) of the first ruler member (12) in the second configuration (90) of the combination to form an elongated straight ruler;
at least one magnet (87) in the tongue and at least one magnet (85, 86) in the first ruler member in each of the first and second recesses (52, 62), that respectively align with and attract the magnet (87) in the tongue (72) in the respective first and second configurations of the combination (80, 90);
a first detent (83, 84) in the flat bottom of each of the recesses; and
a second detent (82) in the flat bottom of the tongue that is engaged with the first detect in the respective recesses in the first and second configurations of the combination for keeping the tongue from sliding out of the respective recess (52, 62).

2. The combination of claim 1, including an extra pair of alignable magnets (92, 94) in the respective first and second ruler members (12, 32) for causing the rule members to be attracted to each other in an aligned storage configuration of the combination when the upper surface (42) of the second ruler member (32) overlays the upper surface (22) of the first ruler member (12) and the magnet (87) in the tongue (72) is aligned with and attracts the magnet (85) in the first recess (52), the first recess (52) being near the first end (14) of the first ruler member (12) and one of the opposite straight edges (38) of the second ruler member (32) being coplanar with the first straight end (14) of the first ruler member (12) in the first configuration of the combination to form a square (80).

3. The combination of claim 1, including a plurality of magnets in each of the tongue and recesses, the plurality of magnets in the tongue aligning with and having complimenting polarities to the plurality of magnets in the recesses in the respective first and second configurations of the combination.

4. The combination of claim 1, including an extra pair of alignable magnets (92, 94) in the respective first and second ruler members (12, 32) for causing the rule members to be attracted to each other in an aligned storage configuration of the combination when the second ruler member overlays the first ruler member and the magnet (87) in the tongue is aligned with the magnet (85) in the first recess (52), and a plurality of magnets in each of the tongue and recesses, the plurality of magnets in the tongue aligning with and having complimenting polarities to the plurality of magnets in the recesses in the respective first and second configurations of the combination.

5. The combination of claim 1, including a four magnets in each of the tongue and recesses, the four magnets in the tongue aligning with and having complimenting polarities to the four magnets in the recesses in the respective first and second configurations of the combination and the four magnets in the tongue attracting the four magnets in the first recess in the storage configuration.

6. The combination of claim 1, wherein the selected shape of the tongue and recesses is rectangular.

7. The combination of claim 1, wherein the selected shape of the tongue and recesses is rectangular, the combination including a four magnets in each of the tongue and recesses near corners of each of the rectangular selected shapes, the four magnets in the tongue aligning with and having complimenting polarities to the four magnets in the recesses in the respective first and second configurations of the combination and the four magnets in the tongue attracting the four magnets in the first recess in the storage configuration.

8. The combination of claim 1, including graduated distant markings (102, 104) on at least one of the upper and lower surfaces of each of the ruler members (12, 32), along at least one of the opposite edges of each ruler member.

9. The combination of claim 1, including graduated distant markings (102, 104) on at least one of the upper and lower surfaces of each of the ruler members (12, 32), along each of the opposite edges of each ruler member, the distance marking along one edge of each ruler member being English distance marking and the distance marking along the opposite edge of each ruler member being metric distance marking.

10. The combination of claim 1, wherein the second ruler member (132) includes a third recess (162) in its upper surface near its second end, the third recess (162) having a third flat bottom and having said selected shape, a depth from the upper surface of the second ruler member (132) to the third flat bottom being equal to said depth of the first recess (52), and the third recess (162) being open into the second end of the second ruler member (132).

11. The combination of claim 1, including a third ruler member (132) having a tongue extending from a first end of the third ruler member and having substantially said selected shape and having a thickness substantially equal to said depth, the tongue of the third ruler member (132) having a width that is offset inwardly of both opposite straight edges of the third ruler member, the tongue of the third ruler member (132) having a lower surface that is offset from a plane on a lower surface of the third ruler member by a selected amount so that in a further configuration, lower surfaces of the ruler members are also coplanar, at least one magnet in the tongue of the third ruler member that respectively aligns with and attracts magnet in at least one of the recesses in the further configuration, and a third detent in the flat bottom of the tongue of the third ruler member to engage with the first detect in one of the respective recesses in further configuration.

12. A combination ruler and square comprising:
first and second elongated straight ruler members;
the first ruler member have first and second recesses in an upper surface thereof, the first recess opening at a side of the first ruler member and the second recess opening at one end of the first ruler member;
the second ruler member having a tongue extending from an end of the second ruler member that is received in the respective first and second recesses to form first and second configurations of the combination that respectively create a square and an elongated ruler;
respective alignable and attracting magnets in the tongue and in the recesses for attracting the tongue in the respective recesses in the first and second configurations; and
respective engageable detents in the tongue and in the recesses for retain the tongue in the respective recesses in the first and second configurations.

13. The combination of claim 12, including a plurality of magnets in each of the tongue and recesses, the plurality of magnets in the tongue aligning with and having complimenting polarities to the plurality of magnets in the recesses in the respective first and second configurations of the combination, and an extra pair of alignable magnets in the first and second ruler members for causing the rule members to be attracted to each other in an aligned storage configuration of the combination when upper surfaces of the first and second ruler members overlay each other, the extra pair of alignable magnets in the first and second ruler members being located so that in the aligned storage configuration the magnet in the tongue and magnet in the first recess also attract each other.

14. The combination of claim 12, including a four magnets in each of the tongue and recesses, the four magnets in the tongue aligning with and having complimenting polarities to the four magnets in the recesses in the respective first and second configurations of the combination and the four magnets in the tongue attracting the four magnets in the first recess in the storage configuration.

15. The combination of claim 12, wherein the selected shape of the tongue and recesses is rectangular.

16. The combination of claim 12, wherein the selected shape of the tongue and recesses is rectangular, the combination including a four magnets in each of the tongue and recesses near corners of each of the rectangular selected shapes, the four magnets in the tongue aligning with and having complimenting polarities to the four magnets in the recesses in the respective first and second configurations of the combination and the four magnets in the tongue attracting the four magnets in the first recess in the storage configuration.

17. The combination of claim 12, including graduated distant markings on the at least one of the upper and lower surfaces of each of the ruler members, along at least one of the opposite edges of each ruler member.

18. The combination of claim 12, including graduated distant markings on at least one of the upper and lower surfaces of each of the ruler members, along the opposite edges of each ruler member, the distance marking along one edge of each ruler member being English distance marking and the distance marking along the opposite edge of each ruler member being metric distance marking.

19. The combination of claim 12, wherein the second ruler member has a recess at its end opposite from the tongue with a magnet and detent for engaging a tongue of another ruler member.

20. The combination of claim 12, including the third ruler member with a tongue at one end and a recess at an opposite end, each with a magnet and detent for engaging a recess or tongue of another ruler member.
